(19) United States
(12) Patent Application Publication
(10) Pub. No.: US 2017/0212928 A1
(43) Pub. Date: Jul. 27, 2017

(54) COGNITIVE DECISION MAKING BASED ON DYNAMIC MODEL COMPOSITION

(71) Applicant: International Business Machines Corporation, Armonk, NY (US)

(72) Inventors: Ermyas Teshome ABEBE, Melbourne (AU); Cristian VECCHIOLA, Melbourne (AU)

(21) Appl. No.: 15/007,294

(22) Filed: Jan. 27, 2016

(51) Int. Cl. G06F 17/30; G06N 5/02

(52) U.S. Cl. CPC G06F 17/30442; G06N 5/02; G06F 17/3053

(57) ABSTRACT

Various embodiments respond to a query in a cognitive decision-making system. In one embodiment, a query is received and a plurality of analytical tools defined in a knowledge base that are to be used to produce a response are identified. A workflow sequence is constructed based on a dependency graph of the identified analytical tools. Each analytical tool within the workflow sequence is executed to create a plurality of outputs. The workflow sequence is updated based on the outputs and the response is provided based on the outputs. At least one of a topic, an entity, a relationship and an unknown parameter within the query may be identified using natural language processing. The analytical tools may be digital tools or physical tools. Feedback on the response is received based on a confidence level and the knowledge base is updated based on the received feedback.

### BACKGROUND

The present disclosure generally relates to cognitive decision making, and more particularly relates to answering questions applied to systems having complex dynamics, for which programming all procedural steps required to provide answers of interest in that domain is not possible.

Today systems exist that can provide reasonable answers to questions like “What will be the weather like today?” or “Who was Charles Darwin?”. These systems rely on the ability of understanding what is asked via natural language processing techniques and leveraging a corpus of data to mine for an answer. Advanced methods can be used to relate relevant information to the question posed and recover further information based on that refinement, but what has been asked is identified clearly and a considerable effort in providing an answer relies upon the information retrieval component of the process.

However, there are questions that significantly depart from this basic, yet difficult to solve structure. Some of these questions require developing a chain of steps that can depend on the findings generated by an initial guided search (or an event). Questions like:
1. “What actions do I have to take to prevent traffic congestion?”
2. “How do I have to change my logistic operations to handle disruption of service in port X?”
3. “Will the current storm affect any hospital in the region, and what kind of resources are required to ensure community safety?”
   require a higher level of reasoning than currently provided to be answered with useful insights.

### BRIEF SUMMARY

In one embodiment, a computer-implemented method for responding to a query is disclosed. The method comprises receiving a query, identifying a plurality of analytical tools defined in a knowledge base that are to be used to produce a response, constructing a workflow sequence based on a dependency graph of the identified analytical tools, executing each analytical tool within the workflow sequence to create a plurality of outputs, updating the workflow sequence based on the outputs and providing the response based on the outputs.

In another embodiment, a cognitive decision-making system for responding to a query is disclosed. The cognitive decision-making system comprises memory and a processor that is operably coupled to the memory. The cognitive decision-making system further comprises a cognitive engine operably coupled to the memory and the processor. The cognitive engine is configured to perform a method comprising receiving a query, identifying a plurality of analytical tools defined in a knowledge base that are to be used to produce a response, constructing a workflow sequence based on a dependency graph of the identified analytical tools, executing each analytical tool within the workflow sequence to create a plurality of outputs, updating the workflow sequence based on the outputs and providing the response based on the outputs.

In yet another embodiment, a computer program product for responding to a query is disclosed. The computer program product comprises a storage medium readable by a processing circuit and storing instructions for execution by the processing circuit for performing a method. The method comprises receiving a query, identifying a plurality of analytical tools defined in a knowledge base that are to be used to produce a response, constructing a workflow sequence based on a dependency graph of the identified analytical tools, executing each analytical tool within the workflow sequence to create a plurality of outputs, updating the workflow sequence based on the outputs and providing the response based on the outputs.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram illustrating one example of an operating environment comprising a cognitive decision-making system according to one embodiment of the present disclosure;

FIG. 2 illustrates one example of an analytical modeling tool used in accordance with one example of the present disclosure;

FIG. 3 is an operational flow diagram illustrating one process of decision making in a cognitive decision-making system according to one embodiment of the present disclosure;

FIG. 4 shows a model used in one example of a dependency graph of identified analytical tools according to one embodiment of the present disclosure;

FIG. 5 is an operational flow diagram illustrating a process verifying whether an entity is a given object using a cognitive decision-making system according to an embodiment of the present disclosure; and

FIG. 6 is a block diagram illustrating one example of an information processing system according to one embodiment of the present disclosure.

### DETAILED DESCRIPTION

Existing systems support certain types of decision making. These systems are based on the fact that the identified conditions are considered to have predictable causes and specified analytical workflows can be triggered as a result of monitoring the symptoms of these causes. In reality, these systems reduce the space of the possible causes to those recognized as the most probable and define a procedure for triggering a process that respond to those causes. These systems are also implemented and customized very accurately to solve the selected set of predefined questions and are often based on the concept of indicators which aim to get the attention of the user so that he or she can act upon on these indicators.

Because of these limitations, such systems have a limited capability to answer open ended questions even in the specialized domains for which they have been customized. For example, these systems are not able to capture the relevance of new events or potential conditions as well as causes of the very same situations they ale trying to address simply because the knowledge of such conditions has not been pre-programmed into the systems. Therefore, these systems have limited predictive capabilities.

One problem faced by cognitive decision-making systems is how to compose available services to achieve a known goal. The following example demonstrates this problem. The goal of the system is to “Identify all the restaurants that sell pizza on my way home,” and the following assumptions are made:
1) There exists a service that provides information about restaurants and their menus. [WS1]
2) There exists a service that computes trajectory given an address (e.g., Google “directions to/from here”). [ WS2]
   To satisfy the goal mentioned above, the system utilizes the information produced by WS1, feeds part of this information to WS2, and eventually aggregates/filters the results. The challenges faced in solving this problem with a general method relies primarily on the discovery and matching of the services.

Aspects of the present disclosure address the challenge of incrementally creating evidence to answer a decision problem and address open questions in the format: “What is . . . ?”, “How do I have to . . . ?”, which often require the identification of a cause or a method respectively, rather than finding information. Aspects of the present disclosure use a different approach based on cognitive technologies and dynamic composition of analytical workflow to lead to a more flexible way to provide decision support capabilities, thus overcoming the limitations mentioned above.

One approach of the present disclosure is based on cognitive technologies and dynamic composition of analytical workflow that can lead to a more flexible way to provide decision support capabilities, thus overcoming the limitations mentioned above.

A cognitive model is extended to include knowledge of analytical and/or physical tools by introducing a semantic model of these tools such that the system can apply reasoning about these tools, on demand, in a semi-guided fashion to provide answers to more complex questions. Primary components of such a system include a cognitive computing engine, an extensible knowledge base where conceptual models about analytical (and physical) tools are stored, an extended corpus of knowledge that includes not only data but also the knowledge base mentioned in the previous point and a feedback loop that enables the system to understand the effectiveness of the analytic chain developed to answer a question based on decision maker rating. The feedback loop ensures that the system has a mechanism by which it learns, corrects, and reinforces its behavior via experience and feedback that can be used to improve its capabilities over time.

A basis of the innovation brought by this idea is the development of a conceptual model of analytical tools and organizing such tools into a framework that can be queried. Analytical tools are described in terms of:
1. The type of capability the tool exposes.
2. The type of information (or objects in case of physical tools, such as machines) the tool consumes.
3. The type of insight (or output) the tool produces.
4. Additional constraints that need to be met in order to be applied (e.g., runtime conditions such as context properties that need to be valid to make a sensible use of the tool).
5. Resources requirements that need to be met to enact the tool.

As events unfold or questions are formulated to the system, a context is built. Such context contains the information that has been acquired by the system so far, including, for instance, the collection of concepts and facts that have been demonstrated to be true or valid for the purpose of answering the question (knowledge base) initially formulated. Moreover, information about the current processing state is added to the context and such information is used to query the semantic knowledge base of the analytical tools to identify the set of tools that would be reasonable to apply for advancing the current understanding of facts and progress through the question answering process.

The system may also have physical extensions in order to carry out analysis that involve physical objects, by enacting such tools rather than being limited to the processing of pure digital information. Physical extensions could, for instance, include thermal scanning machines, radio sensing devices, and so on. This approach avoids the need of encoding the sequence of steps to solve problems, with the potential of answering questions for which the system was not specifically programmed. This idea brings the advantage of leveraging reasoning about not only information and facts, but also the tools that can be used to derive facts and identify properties. A system with these capabilities is able to address a larger set of questions (and potentially more complex questions) than those currently existing, for which, in order to provide a new capability, new analytical workflow processes or indicators would need to be programmed into the system.

Operating Environment

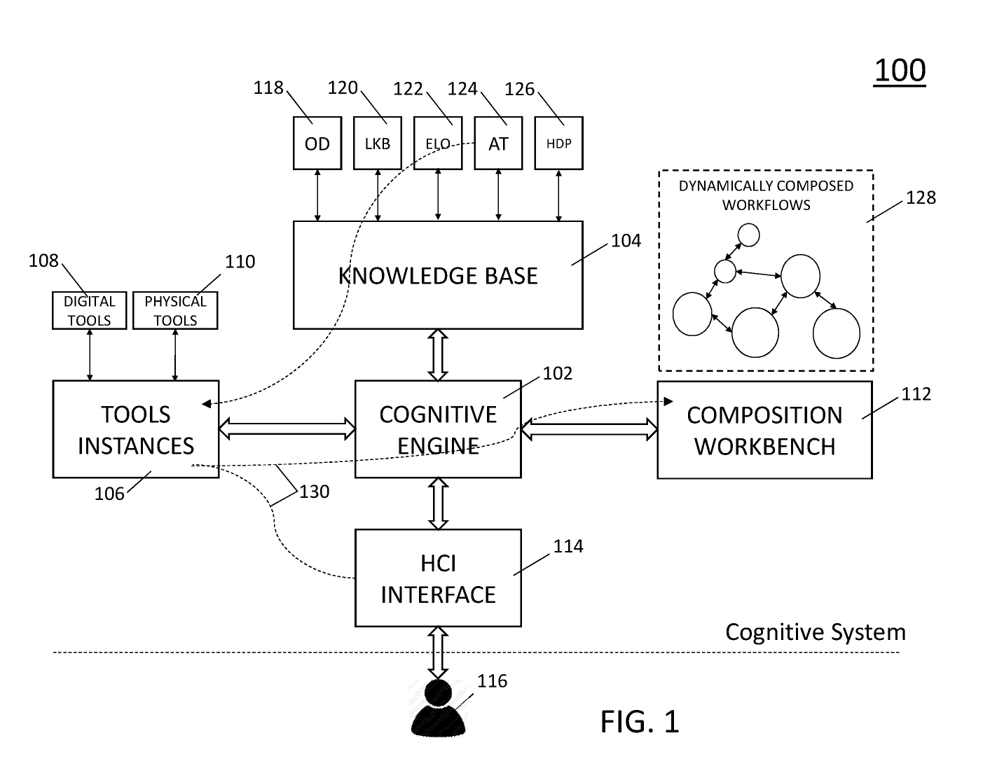

FIG. 1 shows one example of an operating environment of a cognitive decision-making system 100 for providing reasonable answers to complex and open-ended questions according to one embodiment of the disclosure. The operating environment 100 comprises a cognitive engine 102, an extensible knowledge base 104 where conceptual models about analytical and physical tools are stored, tool instances 106 including both digital tools 108 and physical tools 110, a composition workbench 112 and a human/computer interface 114 for interacting with a user 116.

The core of the system 100 is composed by the cognitive engine 102, which is responsible for the reasoning required for the question answering and problem solving activities. The cognitive engine 102 sources the information to operate from the knowledge base 104, which is composed by a set of diverse elements including an open domain knowledge base 118, a local knowledge base 120, evolving live ontology 122, analytical tools knowledge base 124 and a history of decisions paths and outcomes 126.

The open domain knowledge base 118 is primarily derived from the connected information available in the outside world (i.e. a gateway to the Internet).

The local knowledge base 120 is composed of a set of curated and annotated datasets that constitute the primary application domain for the described cognitive system. The information entered in the local knowledge base 120 is properly structured and semantically annotated so that the system 100 can better leverage the information during the reasoning process.

The evolving live ontology 122 is a repository of the concepts and relationships that the system 100 builds over time as a result of the interaction with a decision maker (e.g., a user, group of users, or administrator), the collection of the system's 100 feedback, and the analysis of the analytical compositions that are defined and enacted to solve the question posed by the decision maker. This evolving live ontology 122 also stores the definitions of the concepts that are referred by the semantic annotation in the local knowledge base 120 and the semantic metadata associated used in the analytical tools knowledge base 124.

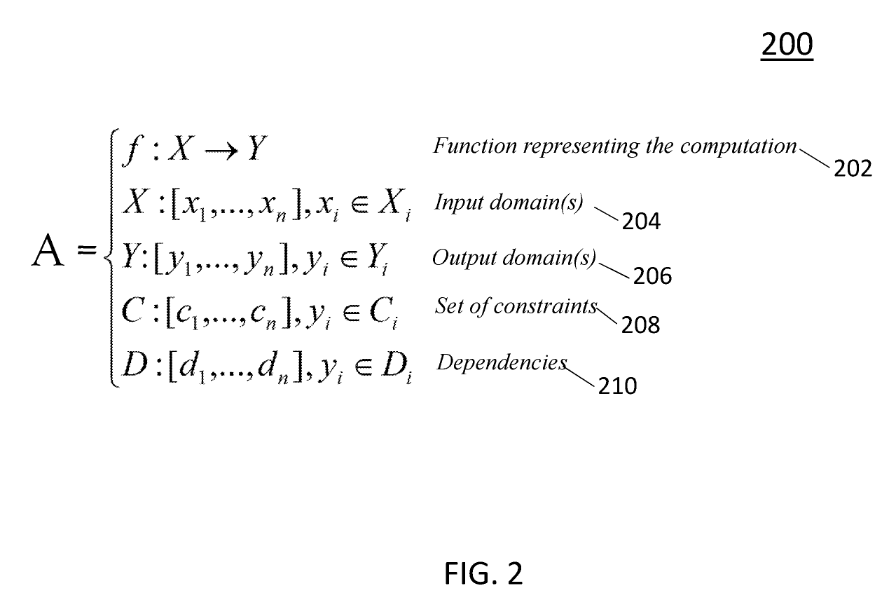

The analytical tools knowledge base 124 contains a definition, enriched with semantic annotations, of each analytical tool known and accessible to the cognitive system 100. The information contained in this knowledge base is modelled upon the conceptual model 200 described in FIG. 2. Such tools listed in the analytical tools knowledge base 124 are accessible and can be enacted by the cognitive engine 102, since these tools are an essential part of the reasoning process to solve the question posed by the decision maker. The conceptual model 200 of the analytical tools enable the system 100 to reason about each tool and make use of these tools during the decision process. An analytical tool can be modelled by the following construct 200: a function 202 (e.g., ƒ: X→Y) representing the computation, a set of input domain(s) 204 (e.g., X: [x₁, . . . , xₙ], xᵢεXᵢ, a set of output domain(s) 206 (e.g., Y: [y₁, . . . , yₙ], yᵢεYᵢ), a set of constraints 208 (e.g., C: [c₁, . . . , cₙ], cᵢεCᵢ], and a set of dependencies 210 (e.g., D: [d₁, . . . , dₙ], dᵢεDᵢ). The input domain(s) 204 and the output domain(s) 206 may be defined as a vector of entities that belong to different domains in order to be able represent and express a wide variety of elements of interest. The same applies to the set of constraints 208 and dependencies 210.

This type of formalization is primarily used to have a model of the tool, which can be digitally persisted and therefore inserted into a knowledge base 104. Another important aspect is the fact that analytical modelling tools are enriched with semantic annotations about their function, application areas that can be used by the cognitive engine 102 to reason about the tools and identify those tools that could be relevant to solve the current question being posed. Semantic annotations also include information about the input required by the analytical tool and the output produced. This information is valuable, for instance, to verify pre-conditions for executions and assess the usefulness of the application of the tool according to the potential outcome that is derived.

The history of decisions paths and outcomes 126 provides information on the past performance of the system 100 against questions posed. The history of decisions paths and outcomes 126 keeps track of the compositions developed by the system 100 to lead to a given answer and also information about how the decision has been assessed by the decision maker that posed the question. This knowledge base builds over time as a result of the system 100 interaction with the decision maker. The history of decisions paths and outcomes 126 prevents repetition of previous mistakes or unsuccessful composition for any given answer, enriches the evolving live ontology 122 with new relationships between concepts, and builds the domain experience of the cognitive system 100.

Extending the knowledge base 104 with a semantic model about tools is not sufficient for the cognitive engine 102 to be able to reason about tools. The final goal of the described cognitive system 100 is to provide decision support for sophisticated questions. In order to do so, the cognitive system 100 enacts such analytical modelling tools and reasons about the information (or new evidence) that is being generated by the execution of such tools against data. Therefore, another component of the system 100 is the repository of tool instances 106. These tool instances 106 can either be physical tools 110 or digital tools 108.

Physical tools 110 are physical devices that are connected to the cognitive system 100 and that provide information through a digital interface that can be either triggered or queried. Some examples of these tools can be: a scanner (2D or 3D) that is capable of scanning physical objects and provide a 2D (image) or 3D model of them, a digital scale that is able to weight objects and provide a number representing their weight, sensors (e.g., temperature, humidity, etc.) which can be used to monitor an environment continuously, etc. Eventually, the information produced by these physical tools 110 is expected to be converted into a digital format so that it can be managed by the cognitive engine 102.

Digital tools 110 are essentially computer algorithms and systems that perform a given analytic function. These digital tools 110 can either be deployable software components or connected services to the system 100 to which information can be routed as input and returned from as output. Examples of such tools can be: a physical modeling capability (e.g., weather modeling, flood modeling, fire spread behavior modeling, etc.), a mathematical modeling capability (e.g., optimization, integer programming, etc.), text analytics capabilities (e.g., concepts and relationship extraction, natural language processing (NLP), etc.), and so on.

The enactment information stored in the analytical tool knowledge base 124 enables the system 100 to enact such tools 106. Moreover, the enriched semantic metadata about their function, input, and outputs, is utilized by the cognitive engine 102 for their composition.

The tool instances 106 are tied to both to the HCl interface 114 and the composition workbench 112. The HCl interface 114 is the primary source of interaction between the decision maker and the cognitive system 100, while the composition workbench 112 is the “environment” where compositions are executed. The HCl interface 114 could, for instance, provide access to the physical tools 110 (e.g., scanners and digital scales) that can be used during the decision making process. The HCl interface 114 could also provide interfaces to either visualize the output of some of these tools 106 or the opportunity of configuring some of these tools 106 if needed. The composition workbench 112 is the software environment where some or all the tool instances 106 are executed and composed. The composition workbench 112 is the component of the system 100 that, when instructed by the cognitive engine 102, executes, in a controlled environment, the digital tools 108 and routes the information of dynamically composed workflows 128 where needed for execution.

The extension of the knowledge base 104 to include both physical tools 110 and software analytical modelling tools 108 is a novel concept of the present disclosure. By properly modeling these elements and enriching them with appropriate semantics, the cognitive engine 102 is enabled to reason about the function of these tools 108, 110 for the purpose of problem solving/question answering. Because this knowledge matters only if such tools 108, 110 can be enacted, it naturally follows that a repository of tools instances 106 is connected to the system 100 as described above.

A feedback loop 130 enables the system 100 to understand the effectiveness of the analytic chain developed to answer a question based on decision maker rating.

One embodiment of the present disclosure is a system 100 providing decision support capabilities within a given domain using analytical modeling capabilities and their static and dynamic relationship derived from both the knowledge base 104 and the historical data about previous executions 126 to provide decision makers with insights. The interaction between the decision maker and the system 100 can either be triggered through a question posed by the decision maker or as a form of alert resulting from reasoning about streaming information. In this second case, if the reasoning produces a state that violates (or might violate) predefined domain constraints, an alert will be produced.

The case of answering open-ended questions in a closed domain will be addressed first. This type of scenario has applications in emergency management, healthcare, smarter cities, etc. Essentially, the system 100 maps a question to a sequence of analytical steps that need to be executed to arrive at a probable solution. Such sequence of analytical steps is built by interrogating the knowledge base 104 that characterizes the domain and the historical data from previous executions to identify whether any relevant questions have been posed before. This sequence of steps is referred to as workflows 128 since they involve a structured execution of steps which are partially ordered. The workflow 128 of analytical steps identified could be “Pre-computed/Static,” “Evolving/Dynamic,” or a combination of both.

In the case of static workflow, the system 100 identifies the sequence of analytical steps to be computed based solely on the knowledge base of analytical tools 124 and the given question. The case of a static workflow can be easily understood as being one of the following:
1. Retrieval of a previous execution considered satisfactory for the posed question in the past and from which the structure is extracted and re-executed; and
2. Retrieval of a set of set of relationships in the knowledge base 104 that can be directly mapped into a set of analytical steps that will provide the answer.

In the case of a dynamic workflow, the sequence of analytical steps is determined during the execution phase, based on the output of preceding analytical steps in the execution flow and emerging contextual information. The sequence of execution in such a scenario would be explicitly controlled by the cognitive component which analyzes the output of modules and determines subsequent actions, or may be implicit in the dependencies of analytic components where certain dependencies between components is predicated on the output of analytic system. For instance, a fire simulator might depend on the output of a weather simulator, but its execution could occur only under certain weather conditions output by the service.

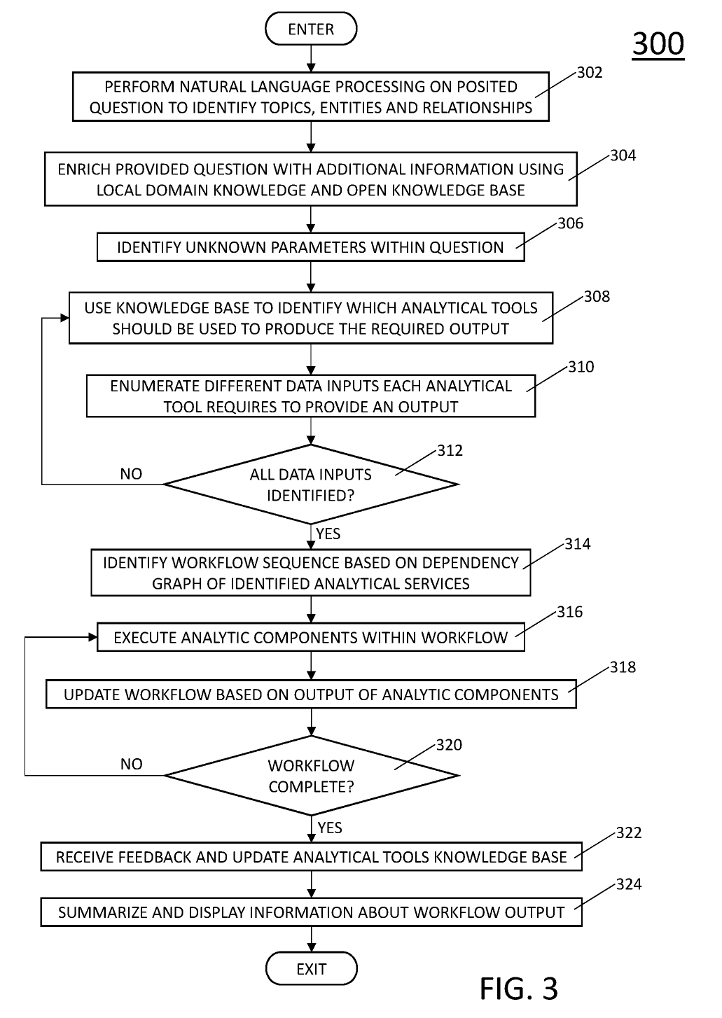

FIG. 3 is an operational flowchart 300 that identifies the general sequence of computation for a dynamic workflow according to one embodiment of the present disclosure. Given an open question, the cognitive engine 102 performs, at step 302, natural language processing on the posited question to identify topics, entities, relationships. Natural language processing methods are known in the art. Each provided question is enriched, at step 304, with additional information (e.g., add specificity, add domain constraint etc.) using the local domain knowledge base 120 and the open domain knowledge base 118. Unknown parameters within the given question are identified, at step 306, and considered as requested output. The analytical tools knowledge base 124 or supportive information is used, at step 308, to identify which analytical tools should be used to produce the requested output. The different data inputs that each analytical tool requires to provide an output are enumerated, at step 310. If all data inputs are known to be available or identified as not accessible, at step 312, the cognitive engine 102 proceeds to identify, at step 314, a workflow sequence based on a dependency graph of analytical services identified by iterating the available analytical tools. Otherwise, the cognitive engine 102 continues identifying and enumerating available analytical tools, at steps 308 and 310, until all available tools have been identified.

After the workflow sequence has been identified, at step 314, the cognitive engine 102 executes, at step 316, analytic components within the workflow and updates, at step 318, the workflow based on the output of analytic components. Steps 316 and 318 are repeated, until workflow is completed and/or all unknown parameters identified in step 306 are answered, at step 320. Feedback on efficacy of execution is received, at step 322, from the decision maker and the analytical tools knowledge base 124 is updated. Information about the output of workflow execution is summarized and displayed to the decision maker, at step 324.

During steps 302 through 314, the cognitive engine 102 composes an initial workflow that can provide insights to answer the posed question. A confidence score to such workflow may be assigned based on the strength of the relationships (cause-effect) between the different steps identifying the execution chain, or whether some of the inputs are identified as not available but the corresponding analytical tools can still be executed (for instance, with an impact of the precision of the results).

During steps 316 through 320, the output of the execution of each stage updates the states of the current execution and is constantly assessed to verify whether the initial workflow needs to be modified based on new evidence. Conditions that can lead to modification of the execution of the workflow are dependent upon the run-time state and therefore the output of the intermediate steps. More precisely, these conditions are dependent upon the particular set of values that the result assumes. As a result of this dependency, the next step of the workflow may not be executed because preconditions about the inputs are not met (e.g., values below threshold or not in range) or changes in the analytical tools are made because the specific instances of the results (or combinations of different results) have led in the past to trigger other analytical tools whose relevance is only identifiable by mining the historical execution.

At the completion of the workflow, at steps 322 through 324, the cognitive engine 102 presents the decision maker with a confidence level on the execution so that the decision maker may evaluate the summary and score the output. This information is entered in the history of decisions paths and outcomes 126, along with the question posed and metadata of the instance of the workflow. The results can lead the decision maker to ask for execution of a specific set of analytical tools as a further exploration path. The experience of the decision maker is incorporated on a case-by-case basis into the system 100 for improving the cognitive capabilities of the system 100.

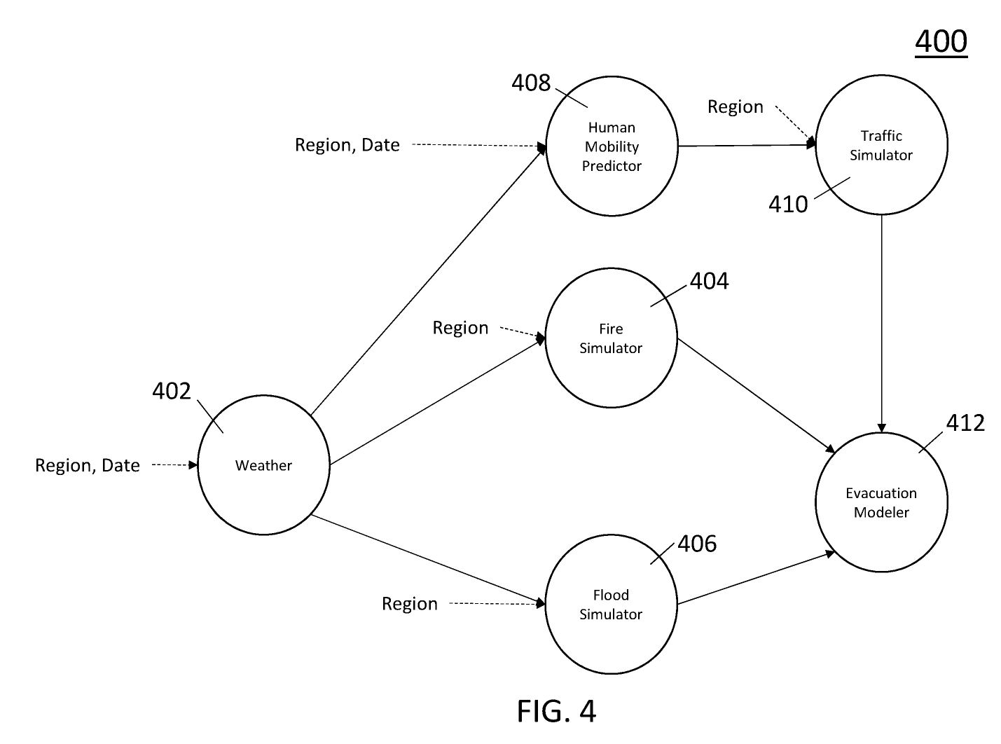

The construction of the workflow can be from a goal state backward and forward. For example, consider the following question: “What would the potential impact of tomorrow's weather be on the city?” The overall cognitive system constraints are to monitor and maintain normal and safe operation of a city. FIG. 4 shows the analytic capabilities and tools 400 of an example system, which include weather modeling 402, fire simulation 404, flood simulation 406, human mobility predictive modeling 408, traffic simulation 410 and evacuation modeling 412. Inputs for the weather modeling 402 may include a region and date while the outputs may include humidity, temperature and pressure. For the human mobility predictive modeling 408, the inputs may include date, region, and the output of the weather modeling 402, while the outputs may include a mobility pattern. For the fire simulator 404, the inputs may include a region and the output of the weather modeling 402, and the outputs may include a fire progression threat model. The flood simulator 406 may receive a region and the output of the weather modeling 402 as inputs, while outputting a flood threat model. The traffic simulator 410 may receive a region and the human mobility pattern output from the human mobility predictor 408. The traffic simulator 410 may output a time series traffic progression which the evacuation modeling 412 uses as input, along with the fire progression threat model and flood threat model from the fire simulator 404 and flood simulator 406, respectively. The evacuation modeler 412 outputs simulated evacuation outcome statistics based on the received inputs.

The cognitive engine 102 processes the sentence, “What would the potential impact of tomorrow's weather be on the city?” to resolve entities and relationships. Thus, “the city” equals “Melbourne,” “tomorrow” equals “Jun. 1, 2015” and “the impact on . . . Melbourne” implies factors that influence the operations of Melbourne relative to the overall objectives of the system (e.g., safety, normal operations of various services such as traffic, hospitals, etc.). The unknowns within the question are identified (i.e. “tomorrow's weather,” “impact on Melbourne”). Using the analytical tool knowledge base 124, the system 100 would identify “Weather Service” as needed to address the first unknown and enumerate the set of analytical services whose operations are impacted by weather data and influence the constraints of the cognitive system 100. From the example, potential services include human mobility patterns based on date, region and weather conditions, fire simulator 404, flood simulator 406, traffic simulator 410, and an evacuation modeler 412. Each of the above services have data dependencies which are produced by other services. Thus the dependency services are executed first before the dependent services. This sequence of computation forms the execution workflow 400.

The start of the workflow 400 is the weather modeling 402, the output of which determines which weather dependent services apply. As such, the complete enumeration of all dependencies is not required until the output of the execution of the weather service. The weather modeling output is fed to the dependent analytical tools (i.e. human mobility predictor 408, fire simulator 404, flood simulator 406). Depending upon the weather modeling output, the appropriate dependency is invoked. Data dependent executions can be enforced in a number of ways, for instance, the dependent service may be provided the data and the dependent service determines if the parameters specified warrant computation (e.g., fire simulator 404 is provided weather data, and determines if a fire is likely to occur under those conditions and does not compute if the parameters are unlikely, such as temperature near 0 and low wind) or an external data event notification system can ensure that the output meets certain threshold of a service that requires that data as input. Assuming the output of the weather modeling 402 is extreme heat, the fire simulator 404 may compute the likelihood of a fire breaking out and subsequent analytical components shown in FIG. 4 would run.

The results of the execution of the workflow 400 could be summarized by the cognitive engine 102 by processing the output of the final analytic steps. For instance, an output may be “Fire breakout around region X predicted. Evacuations mandatory. Loss of lives and property predicted.” Feedback from the decision maker about efficacy of computation is received and integrated into the analytical tools knowledge base 124.

In the case where alerts are produced based on assessing incoming streaming data, such as for systems used by emergency management, healthcare, smarter cities, etc., it is not possible to compose an initial workflow unless the system is programmed to run predefined workflows. Metadata, which defines the analytical tools may essentially produce an incoming stream of data so that the analytical tools may be used very much like sensors. In this case, basic constraints on the data produced by such analytical tools can trigger the cognitive engine 102 to inspect the knowledge base 104 and the history of decision paths and outcomes 126 to identify whether further analytical tools 106 need to be run. This process is reiterated to identify paths that can violate the predefined domain constraints. In this case, an alert is produced for the decision maker. The decision maker will assess the current outcome in relation to the constraint being violated and provide a score that will be stored together with the dynamic workflow or, as in the previous case, require the execution of other analytical tools.

In another embodiment, the key concepts discussed above are applied to the problem of object recognition. The approach is similar to the first embodiment except that more emphasis is given to the use of physical tools 110, in the form of sensors and actuators, together with analytical tools (where needed). In this approach, a physical object may be identified or a physical object may be verified as an instance of a given entity (e.g., phone, laptop, etc.).

In verifying the nature of a given physical object against a given entity, the end goal is better defined. Essentially, the system 100 initially works backwards from the goal to identify the set of initial probes to start the recognition and forwards from such probe to refine the analysis until a certain level of confidence on the identity of the object is reached.

It is possible that during the process, most likely the forward phase, questions are posed to the decision maker to refine the analysis. To detail better, the following object recognition problem is considered: “Is this object a phone?”

In questions of an assertion nature, the system 100 has a set of defined goal attributes that are checked against the object. For instance, a phone, as represented in the local knowledge base would have attributes (e.g., general shape, size, weight, screen, radio wave within certain frequencies, potentially a Bluetooth signal, etc.). Such attributes are either fixed values or ranges, and essential, optional or dependency relationships might exist between these attributes. The representation of these attributes is considered a core part of knowledge base representation and not a part of this disclosure and thus not discussed in more detail. In this approach, a knowledge base of the capabilities of tools is used to map one or more attribute measurement tools with attributes of objects. If the probing fails in identifying a required attribute, the system 100 responds with a failure condition (e.g., the object is too large to be a phone).

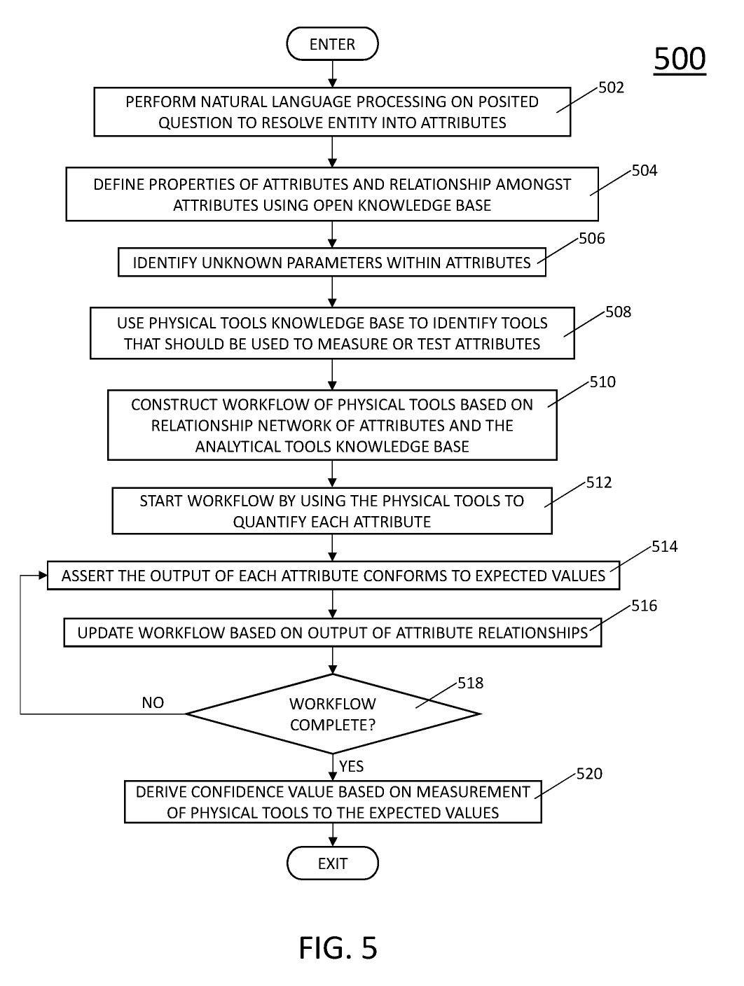

FIG. 5 is an operational flowchart 500 that verifies the nature of a given physical object against a given entity according to one embodiment of the present disclosure. The process begins, at step 502, by performing natural language processing techniques to resolve the entity, (e.g., “phone”) into the attributes defining the entity's properties (e.g., using the open domain knowledge base 118) and the relationship amongst these attributes. The identified attributes of a phone also define, at step 504, the unknown values for the presented “object.” The analytical tools knowledge base 124 is used, at step 508, to identify the physical tools that would be used to measure, or test these attributes. For instance, a size measurement tool to measure the dimensions of an object, a weight scale to measure the object's weight, etc. A workflow of physical tools is constructed, at step 510, based on the relationship network of attributes and the analytical tool knowledge base 124 to quantify the unknown attributes. The workflow is started, at step 512, by using the physical tools to quantify each attribute. The output of each attribute is asserted, at step 514, to conform to expected values (e.g., measured weight of object is within the range of expected weights of a phone). The workflow is updated, at step 516, as required based on the outputs of attribute relationships and steps 516 and 518 are repeated until the workflow is complete, at step 520. A confidence value is derived, at step 520, based on the measurement of the physical tools 110 to the expected values.

It could be possible that this sequence of steps could be altered based on the run-time conditions of the recognition process of the cognitive system 100. In this specific case, a phone as an electronic device could be switched off, therefore testing for a GPS receiver, Wi-Fi receiver, and a radio signal would not be possible. These are capabilities of current phones today, therefore it is valuable to test for these capabilities and if the corresponding physical tools 110 do not sense anything, the system 100 could ask to check whether the device has a switch, and eventually switch the device on.

For a general object recognition problem, there is not given entity to use as a reference and the system 100 may be to be used for answering a question such as “What is this (object)?” In this case, the cognitive engine 102 proceeds forward and starts from the general attributes that define an object (e.g., size, dimensions, weight, color). If an image or 3D scan of the object is available, the cognitive engine 102 will do an initial search by using the knowledge base 104 including the open domain knowledge base 118 (i.e. online repositories) to prune the search space by investigating whether the unknown object could be an instance of the top “N” objects retrieved from the knowledge base 104. This problem is then reduced to a supervised selection (partially by the system 100 itself and partially by the human interacting with the cognitive system 100) of instances of the previous problem.

For each of the problems identified above, an initial workflow of the analytical steps is identified. Because these are workflows to identify objects, the same recognition steps could be present in the different workflows defined for each of the top “N” relevant objects, and therefore the results of the top “N” relevant objects can be reused to shorten the identification process or switch from verifying the given object against a different entity in case the relevance becomes higher. Moreover, at any point in time, the user interaction can guide the cognitive engine 102 to narrow down or expand its search space.

Information Processing System

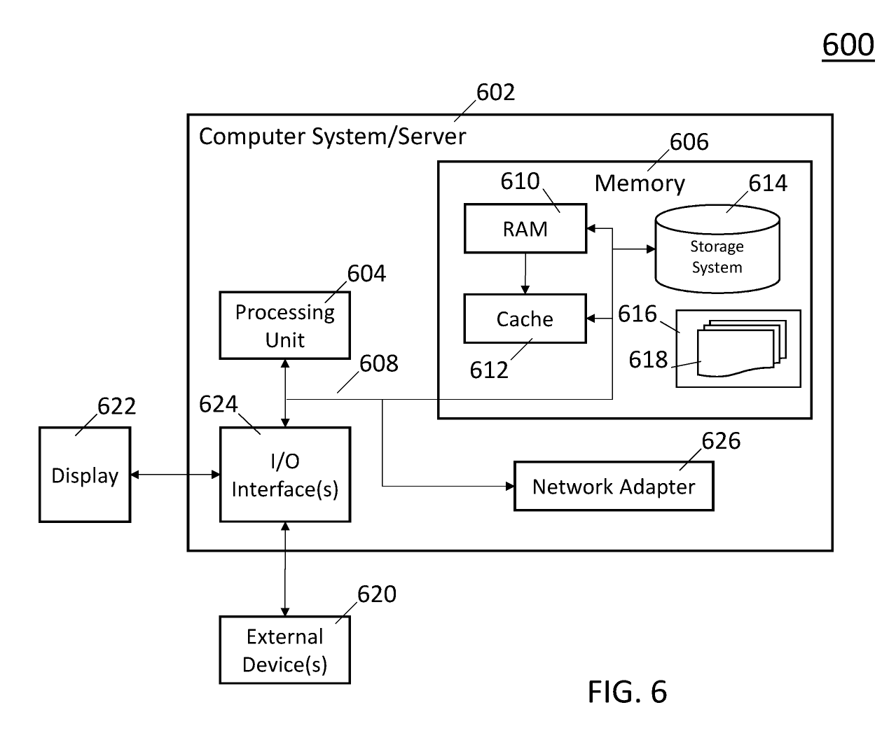

Referring now to FIG. 6, this figure is a block diagram illustrating an information processing system that can be utilized in embodiments of the present disclosure. The information processing system 602 is based upon a suitably configured processing system configured to implement one or more embodiments of the present disclosure (e.g., cognitive decision-making system 100). Any suitably configured processing system can be used as the information processing system 602 in embodiments of the present disclosure. The components of the information processing system 602 can include, but are not limited to, one or more processors or processing units 604, a system memory 606, and a bus 608 that couples various system components including the system memory 606 to the processor 604.

The bus 608 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 6, the main memory 606 may include cognitive engine 104, the knowledge base 104, the tools instances 110, the composition workbench 112, and the HCl interface 114 and their components, and the various types of data 108, 110, 118, 120, 122, 124, 126, 128 shown in FIG. 1. One or more of these components can reside within the processor 604, or be a separate hardware component. The system memory 606 can also include computer system readable media in the form of volatile memory, such as random access memory (RAM) 610 and/or cache memory 612. The information processing system 602 can further include other removable/non-removable, volatile/non-volatile computer system storage media. By way of example only, a storage system 614 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 608 by one or more data media interfaces. The memory 606 can include at least one program product having a set of program modules that are configured to carry out the functions of an embodiment of the present disclosure.

Program/utility 616, having a set of program modules 618, may be stored in memory 606 by way of example, and not limitation, as well as an operating system, one or more application programs, other program modules, and program data. Each of the operating system, one or more application programs, other program modules, and program data or some combination thereof, may include an implementation of a networking environment. Program modules 618 generally carry out the functions and/or methodologies of embodiments of the present disclosure.

The information processing system 602 can also communicate with one or more external devices 620 such as a keyboard, a pointing device, a display 622, etc.; one or more devices that enable a user to interact with the information processing system 602; and/or any devices (e.g., network card, modem, etc.) that enable computer system/server 602 to communicate with one or more other computing devices. Such communication can occur via I/O interfaces 624. Still yet, the information processing system 602 can communicate with one or more networks such as a local area network (LAN), a general wide area network (WAN), and/or a public network (e.g., the Internet) via network adapter 626. As depicted, the network adapter 626 communicates with the other components of information processing system 602 via the bus 608. Other hardware and/or software components can also be used in conjunction with the information processing system 602. Examples include, but are not limited to: microcode, device drivers, redundant processing units, external disk drive arrays, RAID systems, tape drives, and data archival storage systems.

### Non-Limiting Embodiments

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit”,” “module”, or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer maybe connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for responding to a query, the method comprising:
receiving a query;
identifying a plurality of analytical tools defined in a knowledge base that are to be used to produce a response;
constructing a workflow sequence based on a dependency graph of the identified analytical tools;
executing each analytical tool within the workflow sequence to create a plurality of outputs;
updating the workflow sequence based on the outputs; and
providing the response based on the outputs.

2. The method of claim 1, further comprising identifying at least one of a topic, an entity, a relationship and an unknown parameter within the query;

3. The method of claim 2, wherein the at least one of a topic, an entity, a relationship and an unknown parameter within the query is identified using natural language processing.

4. The method of claim 1, wherein the analytical tools comprise at least one of digital tools and physical tools.

5. The method of claim 4, wherein the analytical tools are annotated with appropriate semantics to allow a cognitive engine to reason about capabilities and use of the analytical tools.

6. The method of claim 1, further comprising using both dynamic and static relationships to determine a next step of the workflow sequence.

7. The method of claim 6 wherein using the dynamic relationships comprises:
updating a current stage of execution of the workflow sequence by the outputs; and
assessing each output to verify whether the workflow sequence needs to be modified based on new evidence.

8. The method of claim 1, further comprising:
determining a confidence score for the workflow sequence based on a strength of relationships between steps of the workflow sequence;
receiving feedback on the response based on the confidence score; and
updating the knowledge base with the query, the response, the confidence score, metadata of the workflow sequence and the received feedback.

9. The method of claim 1, wherein an output of at least one analytical tool is used as an input to another analytical tool.

10. The method of claim 1, further comprising displaying the response.

11. A cognitive decision-making system for responding to a query, the cognitive decision-making system comprising:
a memory;
a processor operably coupled to the memory; and
a cognitive engine operably coupled to the memory and the processor, the cognitive engine configured to perform a method comprising:
receiving a query;
identifying a plurality of analytical tools defined in a knowledge base that are to be used to produce a response;
constructing a workflow sequence based on a dependency graph of the identified analytical tools;
executing each analytical tool within the workflow sequence to create a plurality of outputs;
updating the workflow sequence based on the outputs; and
providing the response based on the outputs.

12. The cognitive decision-making system of claim 11, wherein the method further comprises identifying at least one of a topic, an entity, a relationship and an unknown parameter within the query;

13. The cognitive decision-making system of claim 12, wherein the at least one of a topic, an entity, a relationship and an unknown parameter within the query is identified using natural language processing.

14. The cognitive decision-making system of claim 11, wherein the analytical tools comprise at least one of digital tools and physical tools.

15. The cognitive decision-making system of claim 14, wherein the analytical tools are annotated with appropriate semantics to allow a cognitive engine to reason about capabilities and use of the analytical tools.

16. The cognitive decision-making system of claim 11, wherein the method further comprises using both dynamic and static relationships to determine a next step of the workflow sequence.

17. The cognitive decision-making system of claim 16 wherein using the dynamic relationships comprises:
updating a current stage of execution of the workflow sequence by the outputs; and
assessing each output to verify whether the workflow sequence needs to be modified based on new evidence.

18. The cognitive decision-making system of claim 11, wherein the method further comprises:
determining a confidence score for the workflow sequence based on a strength of relationships between steps of the workflow sequence.
receiving feedback on the response based on the confidence score; and
updating the knowledge base based on the received feedback.

19. The cognitive decision-making system of claim 11, wherein an output of at least one analytical tool is used as an input to another analytical tool.

20. A computer program product for responding to a query, the computer program product comprising:
a storage medium readable by a processing circuit and storing instructions for execution by the processing circuit for performing a method comprising:
receiving a query;
identifying a plurality of analytical tools defined in a knowledge base that are to be used to produce a response;
constructing a workflow sequence based on a dependency graph of the identified analytical tools;
executing each analytical tool within the workflow sequence to create a plurality of outputs;
updating the workflow sequence based on the outputs; and
providing the response based on the outputs.
